(19) United States
(12) Patent Application Publication
(10) Pub. No.: US 2016/0232475 A1
(43) Pub. Date: Aug. 11, 2016

(54) SYSTEM AND METHOD FOR RATING DRIVERS

(71) Applicant: BENDIX COMMERCIAL VEHICLE SYSTEMS LLC, Elyria, OH (US)

(72) Inventors: Andreas U. Kuehnle, Villa Park, CA (US); Hans M. Molin, Mission Viejo, CA (US); Donald F. Baechtel, Elyria, OH (US); Luke D. Wood, Costa Mesa, CA (US); Michelle D. Huhn, Sheffield Village, OH (US)

(73) Assignee: BENDIX COMMERCIAL VEHICLE SYSTEMS LLC, Elyria, OH (US)

(21) Appl. No.: 14/865,465

(22) Filed: Sep. 25, 2015

Related U.S. Application Data
(60) Provisional application No. 62/114,323, filed on Feb. 10, 2015.

(51) Int. Cl. G06Q 10/06; G06Q 10/08

(52) U.S. Cl. CPC G06Q 10/063112; G06Q 10/06398; G06Q 10/0838; G06Q 10/08345

(57) ABSTRACT

A method for rating drivers includes associating each of a plurality of segments of a route with a respective one of a plurality of segment types. For each of the plurality of drivers, a respective segment type value associated with each of the segment types is identified, a first condition value associated with a first condition is identified, a second condition value associated with a second condition is identified, and a driver score including respective component values based on the segment type values, the first condition value, and the second condition value is identified. The drivers are rated for one of the segments based on the respective multi-component driving scores.

This application claims the benefit of U.S. Provisional Patent Application No. 62/114,323, filed Feb. 10, 2015, which is hereby incorporated by reference.

### BACKGROUND

The present invention relates to determining driver performance based on a score determined from one or more categories. It finds particular application in conjunction with determining driver performance based on a frequency of critical or safety-related events and will be described with particular reference thereto. It will be appreciated, however, that the invention is also amenable to other applications.

Driver scoring is a tool for grading performance of vehicle drivers. Such scoring tools are used by administrators of heavy vehicle fleets to identify driver behaviors that are consistent or inconsistent with their company policies. Typically, engine diagnostics data obtained, for example, from an engine control module (ECM) and accelerometers are used to infer driving habits and behaviors of a driver. Conventionally, driver score for a particular driver is determined based on the engine diagnostics data.

Difficulty associated with navigating a vehicle (e.g., a heavy vehicle such as a straight truck, an articulated truck, a bus, etc.) along different types of routes varies. For example, it is typically considered more challenging for a driver of a vehicle to navigate a relatively winding and/or narrow road at high speed (e.g., at highway speed) during nighttime as compared with a more leisurely velocity on a straighter, wider road without a lot of traffic during daytime. Because route types and conditions vary, a differentiated scoring based on the route type and conditions such as time of day and other factors is desirable. Conventional driver scoring schemes fail to score a driver based on a difficulty associated with a particular route, type of route, and/or safety-related events associated with the driver.

The present invention provides a new and improved apparatus and method for determining a differentiated scoring scheme for particular drivers.

### SUMMARY

In one embodiment, a method for rating drivers includes associating each of a plurality of segments of a route with a respective one of a plurality of segment types. For each of the plurality of drivers, a respective segment type value associated with each of the segment types is identified, a first condition value associated with a first condition is identified, a second condition value associated with a second condition is identified, and a driver score including respective component values based on the segment type values, the first condition value, and the second condition value is identified. The drivers are rated for one of the segments based on the respective multi-component driving scores.

### BRIEF DESCRIPTION OF THE DRAWINGS

In the accompanying drawings which are incorporated in and constitute a part of the specification, embodiments of the invention are illustrated, which, together with a general description of the invention given above, and the detailed description given below, serve to exemplify the embodiments of this invention.

FIG. 1 illustrates a schematic representation of a map including routes and segments of routes from a starting location to an ending location in accordance with one embodiment of an apparatus illustrating principles of the present invention;

FIG. 2 illustrates a schematic representation of a system for rating drivers in accordance with one embodiment of an apparatus illustrating principles of the present invention; and

FIG. 3 is an exemplary methodology of rating drivers in accordance with one embodiment illustrating principles of the present invention.

### DETAILED DESCRIPTION OF ILLUSTRATED EMBODIMENT

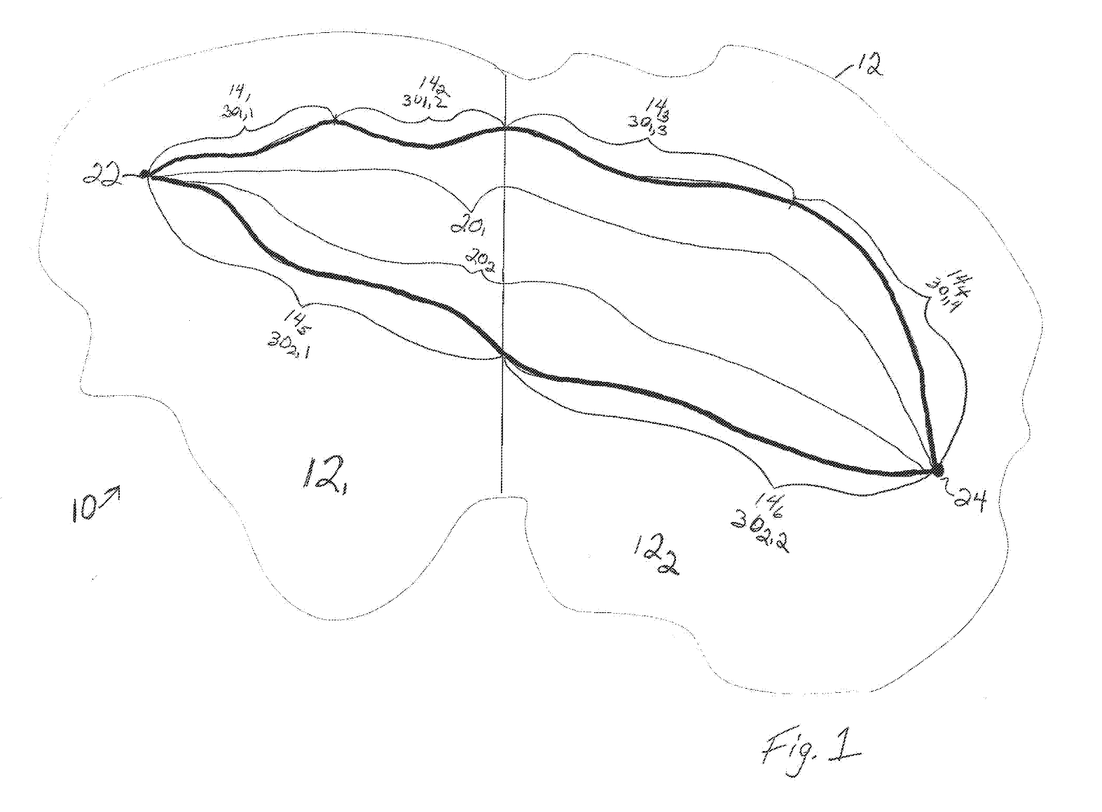

With reference to FIG. 1, a map 10 is illustrated of an area 12. The map 10 displays various roads 14₁-14₆ (collectively 14) in the area 12. Some of the roads 14_{1,4,5} are designated as relatively lower speed roads (e.g., roads having a speed limit less than or equal to a predetermined threshold speed), while other ones of the roads 14_{2,3,6} are designated as relatively higher speed roads (e.g., roads having a speed limit greater than the predetermined threshold speed). In one embodiment, the predetermined threshold speed is 50 miles per hour (mph). However, any other predetermined threshold speed is contemplated in other embodiments. Although all of the roads in the illustrated embodiment are designated as either lower speed roads or higher speed roads, it is to be understood that other embodiments in which additional road designations are used (e.g., four designations including very slow speed roads, low speed roads, medium speed roads, and high speed roads) are also contemplated.

For purposes of discussion, the roads 14_{1,4,5} designated as the relatively lower speed roads are referred to as city roads, and the roads 14_{2,3,6} designated as the relatively higher speed roads are referred to as highway roads. In addition, the map 10 illustrates a first part of the area 12₁ and a second part of the area 12₂. A first condition is associated with the first part of the area 12₁, and a second condition is associated with the second part of the area 12₂. In one embodiment, the first condition is daytime, and the second condition is nighttime. Although the first and second conditions are described as daytime and nighttime, it is to be understood that other conditions (e.g., wet roads vs. dry roads; slippery (e.g., icy) roads vs. not slippery (e.g., not icy) roads, etc.) are also contemplated. Therefore, the city roads 14_{1,5} in the first area 12₁ are city roads for daytime driving, the city road 14₄ in the second area 12₂ is a city road for nighttime driving, the highway roads 14_{2,3} in the first area 12₁ are highway roads for daytime driving, and the highway road 14₆ in the second area 12₂ is a highway road for nighttime driving.

A route 20 is a path along selected ones of the roads 14 from a starting location 22 to an ending location 24. In the illustrated embodiment, a first route 20₁ includes four (4) segments 30_{1,1-4} (collectively 30), where the first subscript (e.g., “1”) represents the first route 20₁, and the second subscript (e.g., “1-4”) represents the segment of the respective route 20. The four segments 30_{1,1-4} of the first route 20₁ include the following four (4) roads: i) a city road 14₁ about five (5) miles in the first area 12₁ (e.g., daytime) (e.g., segment 30_{1,1}), ii) a highway road 14₂ about 12 miles in the first area 12₁ (e.g., daytime) (e.g., segment 30_{1,2}), iii) a highway road 14₃ about 21 miles in the second area 12₂ (e.g., nighttime) (e.g., segment 30_{1,3}), and iv) a city road 14₄ about 14 miles in the second area 12₁ (e.g., nighttime) (e.g., segment 30_{1,4}). A second route 20₂ includes two (2) segments 30_{2,1-2} corresponding to two (2) roads: i) a city road 14₅ about 20 miles in the first area 12₁ (e.g., daytime) (e.g., segment 30_{2,1}) and ii) a highway road 14₆ about 18 miles in the second area 12₂ (e.g., nighttime) (e.g., segment 30_{2,2}).

For purposes of discussion, it is assumed the speed limit in the city road segments 30_{1,1}, 30_{1,4}, and 30_{2,1} is 35 mph, and the speed limit in the highway road segments 30_{1,2}, 30_{1,3}, and 30_{2,2} is 60 mph. Therefore, based on the speed limits and distances of the different segments, the driving time from the starting location 22 to the ending location 24 along the first route 20₁ (i.e., along the segments 30_{1,1-4}) is about 1.1 hours (i.e., (5 miles/35 mph)+(12 miles/60 mph)+(21 miles/60 mph)+(14 miles/35 mph)). The about 1.1 hours time along the first route 20₁ includes about 0.3 hours in the first area 12₁ (e.g., daytime) and about 0.8 hours in the second area 12₂ (e.g., nighttime). The about 1.1 hours time along the first route 20₁ also includes about 0.5 hours on city roads and about 0.6 hours on highway roads. The about 1.1 hours time along the first route 20₁ also includes about 0.1 hours on city roads in the first area 12₁ (e.g., daytime), about 0.2 hours on highway roads in the first area 12₁ (e.g., daytime), about 0.4 hours on city roads in the second area 12₂ (e.g., nighttime), and about 0.4 hours on highway roads in the second area 12₂ (e.g., nighttime).

Based on the speed limits and distances of the different segments, the driving time from the starting location 22 to the ending location 24 along the second route 20₂ (i.e., along the segments 30_{2,1-2}) is about 0.9 hours (i.e., (20 miles/35 mph)+(18 miles/60 mph)). The about 0.9 hours time along the second route 20₂ includes about 0.6 hours in the first area 12₁ (e.g., daytime) and about 0.3 hours in the second area 12₂ (e.g., nighttime). The about 0.9 hours time along the second route 20₂ also includes about 0.6 hours on city roads and about 0.3 hours on highway roads. The about 0.9 hours time along the second route 20₂ also includes about 0.6 hours on city roads in the first area 12₁ (e.g., daytime), zero (0) hours on highway roads in the first area 12₁ (e.g., daytime), zero (0) hours on city roads in the second area 12₂ (e.g., nighttime), and about 0.3 hours on highway roads in the second area 12₂ (e.g., nighttime).

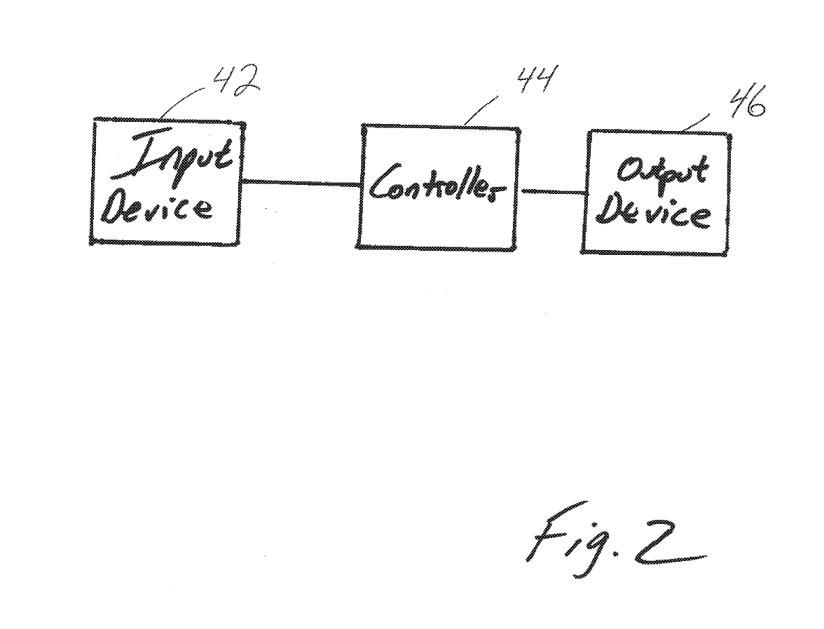

With reference to FIG. 2, a simplified component diagram of an exemplary system 40 for rating drivers is illustrated in accordance with one embodiment of the present invention. The system 40 includes an input device 42, a controller 44 (e.g., computer processor), and an output device 46. The controller 44 electrically communicates with both the input device 42 and the output device 46. In the illustrated embodiment, the controller 44 electrically communicates with the input device 42 and the output device 46 via a wired connection. However, other embodiments, in which the controller 44 electrically communicates with at least one of the input device 42 and the output device 46 via a wireless connection (e.g., via a radio frequency (RF) connection), are also contemplated.

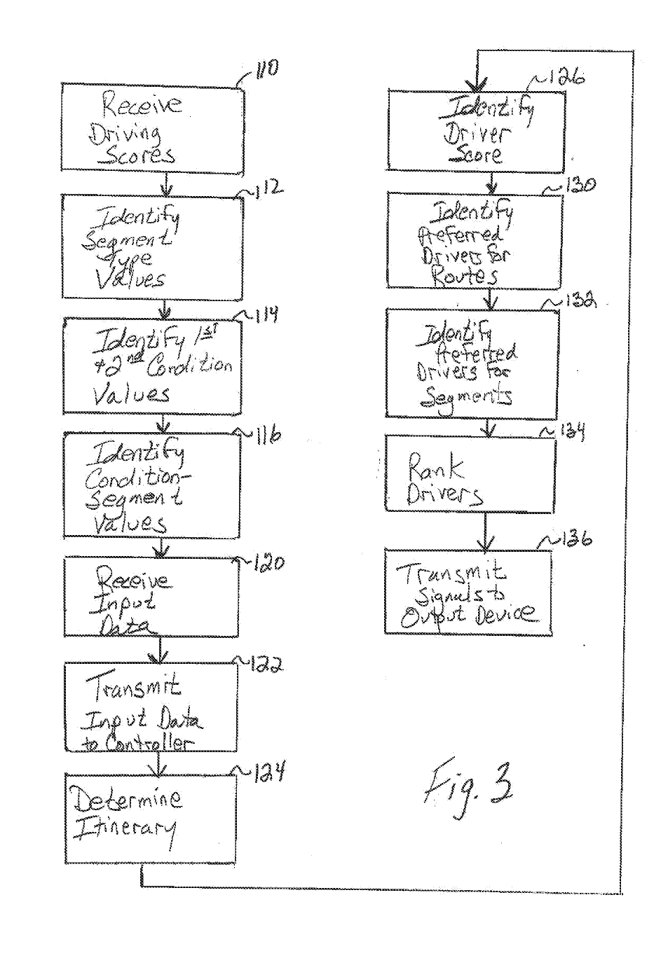

With reference to FIG. 3, an exemplary methodology of the system shown in FIG. 2 is illustrated. As illustrated, the blocks represent functions, actions and/or events performed therein. It will be appreciated that electronic and software systems involve dynamic and flexible processes such that the illustrated blocks and described sequences can be performed in different sequences. It will also be appreciated by one of ordinary skill in the art that elements embodied as software may be implemented using various programming approaches such as machine language, procedural, object-oriented or artificial intelligence techniques. It will further be appreciated that, if desired and appropriate, some or all of the software can be embodied as part of a device's operating system.

With reference to FIGS. 1-3, the controller 44 is adapted to associate each of the segments 30 of the routes 20 with a respective one of a plurality of segment types. In the present example, the segment types include the relatively lower speed roads 14 and the relatively higher speed roads 14. For purposes of discussion, it is assumed the speed limits discussed above (e.g., 35 mph for city road segments and 60 mph for highway road segments) are previously programmed into the controller 44. In a step 110, the controller receives respective driving scores for each of a plurality of drivers. In one embodiment, the driving scores are received by the controller 44 from the input device 42. For example, the driving scores are manually entered into the input device 42 by a user or, alternatively, are included on a removable device that is read by the input device 42. In one embodiment, each of the driving scores is based on a number of safety events per driven mile incurred by the driver while driving in the respective segment types 30 (e.g., driving on city roads and highway roads) and areas 12 (e.g., driving during daytime and nighttime).

A 1^{st} driver may have a record (e.g., driving history value) of two (2) safety events in 500 miles, or 0.40% (i.e., 2/500), while driving on city roads and a record of one (1) safety event in 750 miles, or 0.13% (i.e., 1/750), while driving on highway roads. The same driver may have record of two (2) safety events in 250 miles, or 0.80% (i.e., 2/250), while driving in the first area 12₁ (i.e., daytime driving) and a record of six (6) safety events in 600 miles, or 1.00% (i.e., 6/600), while driving in the second area 12₂ (i.e., nighttime driving). In addition, the 1^{st} driver may have a record of three (3) safety events in 500 miles, or 0.60% (i.e., 3/500) while driving on city roads during the daytime and a record of twelve (12) safety event in 1500 miles, or 0.8% (i.e., 12/1500) while driving on city roads at nighttime. Furthermore, the 1^{st} driver may have a record of seven (7) safety events in 1500 miles, or 0.47% (i.e., 7/1500) while driving on highway roads during the daytime and a record of 17 safety event in 3000 miles, or 0.57% (i.e., 17/3000) while driving on highway roads at nighttime. Therefore, the 1^{st} driver has the best driving score for driving on the highway during the daytime (i.e., 0.47%) and the worst score of driving on the city at nighttime (i.e., 0.8%).

A 2^{nd} may have a record (e.g., driving history value) of five (5) safety events in 500 miles, or 1.00% (i.e., 5/500), while driving on city roads and a record of seven (7) safety event in 300 miles, or 2.33% (i.e., 7/300), while driving on highway roads. The same driver may have record of two (2) safety events in 400 miles, or 0.50% (i.e., 2/400), while driving in the first area 12₁ (i.e., daytime driving) and a record of three (3) safety events in 250 miles, or 1.20% (i.e., 3/250), while driving in the second area 12₂ (i.e., nighttime driving). In addition, the 2^{nd} driver may have a record of three (3) safety events in 800 miles, or 0.38% (i.e., 3/800) while driving on city roads during the daytime and a record of eleven (11) safety event in 1000 miles, or 1.10% (i.e., 11/1000) while driving on city roads at nighttime. Furthermore, the 2^{nd} driver may have a record of seventeen (17) safety event in 1200 miles, or 1.42% (i.e., 17/1200) while driving on highway roads during the daytime and a record of 53 safety event in 3000 miles, or 1.77% (i.e., 53/3000) while driving on highway roads at nighttime. Therefore, the 2^{nd} driver has the best driving score for driving in the city during the daytime (i.e., 0.38%) and the worst score of driving on the highway at nighttime (i.e., 1.77%).

The driving history values for driving on the respective segments (e.g., city roads and highway roads) in the respective areas 12 (e.g., during the respective conditions such as daytime and nighttime), such as driving on a city road during the daytime, driving on a city road during the nighttime, driving on a highway road during the daytime, and driving on a highway road during the nighttime, are referred to as combined values or condition-segment values.

In a step 112, for each of the drivers, the controller 44 identifies a respective segment type value associated with each of the segment types. In the example discussed above, the 1^{st} driver is identified as having a score of 0.40% on city roads and 0.13% while driving on highway roads. The 2^{nd} driver is identified as having a score of 1.00% on city roads and 2.33% while driving on highway roads. Then, in a step 114, for each of the drivers, the controller 44 identifies a first condition value associated with a first condition and a second condition value associated with a second condition. In the example discussed above, the 1^{st} driver is identified as having a score of 0.80% for the first condition (e.g., daytime driving) and 1.00% for the second condition (e.g., nighttime driving). The 2^{nd} driver is identified as having a score of 0.50% for the first condition (e.g., daytime driving) and 1.20% for the second condition (e.g., nighttime driving). Then, in a step 116, the combined values (e.g., condition-segment values) of city driving during the daytime, city driving during the nighttime, highway driving during the daytime, and highway driving during the nighttime, which are also discussed above, are also identified for each of the drivers.

In a step 120, the input device 42 receives input data from, for example, a user. In a step 122, the input data is transmitted from the input device 42 to the controller 44.

In one example, the input data received by the input device 42 includes the starting location 22 and the ending location 24 and starting date and time. In another example, the input data includes an itinerary including at least one portion. Each of the at least one portions identifies one of the segments 30 and one of a plurality of conditions associated with each of the segments 30. In one embodiment, the plurality of conditions includes daytime and nighttime. To determine the respective condition associated with each of the segments, the user may either input a starting day and time for the starting location 22 or, alternatively, input the respective condition (e.g., daytime or nighttime) in which the driver will is expected to drive on the segment.

Once the controller 44 receives the input data from the input device 42, if the input data merely includes the starting location 22, the ending location 24, and starting date and time (as opposed to an itinerary), the controller 44 determines possible itineraries in a step 124. Two (2) itineraries are illustrated as the first route 20₁ and the second route 20₂ (see FIG. 1). As discussed above, the about 1.1 hours time along the first route 20₁ includes about 0.1 hours on city roads in the first area 12₁ (e.g., daytime), about 0.2 hours on highway roads in the first area 12₁ (e.g., daytime), about 0.4 hours on city roads in the second area 12₂ (e.g., nighttime), and about 0.4 hours on highway roads in the second area 12₂ (e.g., nighttime). Furthermore, the about 0.9 hours time along the second route 20₂ also includes about 0.6 hours on city roads in the first area 12₁ (e.g., daytime), zero (0) hours on highway roads in the first area 12₁ (e.g., daytime), zero (0) hours on city roads in the second area 12₂ (e.g., nighttime), and about 0.3 hours on highway roads in the second area 12₂ (e.g., nighttime).

In a step 126, for each of the drivers, the controller 44 identifies a respective driver score including respective multi-component values based on the segment type values, the first condition value, and the second condition value for the routes 20 for the respective driver. The segment type values are based on segment driving history values which, in turn, are based on the number of safety event incurred by the driver while driving in the respective segment type, while driving in the first condition, and while driving in the second condition. Therefore, the multi-component values are based on the number of safety event incurred by the driver while driving in the respective segment type in the first condition, and while driving in the respective segment type in the second condition.

The driver score for the 1^{st} driver on the first route 20₁ is identified as 0.638 (i.e., 0.1/1.1 (ratio of time on city roads in the first area 12₁ e.g., daytime) 30_{1,1} to total time of the first route 20₁)*0.60 (percentage score of 1^{st} driver on city roads in the daytime)+0.2/1.1 (ratio of time on highway roads in the first area 12₁ (e.g., daytime) 30_{1,2} to total time of the first route 20₁)*0.47 (percentage score of 1^{st} driver on highway roads in the daytime)+0.4/1.1 (ratio of time on city roads in the second area 12₂ (e.g., nighttime) 30_{1,3} to total time of the first route 20₁)*0.80 (percentage score of 1^{st} driver on city roads in the nighttime)+0.4/1.1 (ratio of time on highway roads in the second area 12₂ (e.g., nighttime) 30_{1,4} to total time of the first route 20₁)*0.57 (percentage score of 1^{st} driver on highway roads in the nighttime).

The driver score for the 2^{nd} driver on the first route 20₁ is identified as 1.336 (i.e., 0.1/1.1 (ratio of time on city roads in the first area 12₁ (e.g., daytime) 30_{1,1} to total time of the first route 20₁)*0.38 (percentage score of 2^{nd} driver on city roads in the daytime)+0.2/1.1 (ratio of time on highway roads in the first area 12₁ (e.g., daytime) 30_{1,2} to total time of the first route 20₁)*1.42 (percentage score of 2^{nd} driver on highway roads in the daytime)+0.4/1.1 (ratio of time on city roads in the second area 12₂ (e.g., nighttime) 30_{1,3} to total time of the first route 20₁)*1.10 (percentage score of 2^{nd} driver on city roads in the nighttime)+0.4/1.1 (ratio of time on highway roads in the second area 12₂ (e.g., nighttime) 30_{1,4} to total time of the first route 20₁)*1.77 (percentage score of 2^{nd} driver on highway roads in the nighttime).

Since the 1^{st} driver has a lower driver score than the 2^{nd} driver based on the respective multi-component values (i.e., 0.638<1.336), the 1^{st} driver is identified by the controller 44 in a step 130 as a preferred driver for the first route 20₁.

The driver score for the 1^{st} driver on the second route 20₂ is identified as 0.590 (i.e., 0.6/0.9 (ratio of time on city roads in the first area 12₁ (e.g., daytime) 30_{2,1} to total time of the second route 20₂)*0.60 (percentage score of 2^{nd} driver on city roads in the daytime)+0.0/0.9 (ratio of time on highway roads in the first area 12₁ (e.g., daytime) to total time of the second route 20₂)*0.47 (percentage score of 2^{nd} driver on highway roads in the daytime)+0.0/0.9 (ratio of time on city roads in the second area 12₂ (e.g., nighttime) to total time of the second route 20₂)*0.80 (percentage score of 2^{nd} driver on city roads in the nighttime)+0.3/0.9 (ratio of time on highway roads in the second area 12₂ (e.g., nighttime) 30_{2,2} to total time of the second route 20₂)*0.57 (percentage score of 1^{st} driver on highway roads in the nighttime).

The driver score for the 2^{nd} driver on the second route 20₂ is identified as 0.843 (i.e., 0.6/0.9 (ratio of time on city roads in the first area 12₁ (e.g., daytime) 30_{2,1} to total time of the second route 20₂)*0.38 (percentage score of 2^{nd} driver on city roads in the daytime)+0.0/0.9 (ratio of time on highway roads in the first area 12₁ (e.g., daytime) to total time of the second route 20₂)*1.42 (percentage score of 2^{nd} driver on highway roads in the daytime)+0.0/0.9 (ratio of time on city roads in the second area 12₂ (e.g., nighttime) to total time of the second route 20₂)*1.10 (percentage score of 2^{nd} driver on city roads in the nighttime)+0.3/0.9 (ratio of time on highway roads in the second area 12₂ (e.g., nighttime) 30_{2,2} to total time of the second route 20₂)*1.77 (percentage score of 2^{nd} driver on highway roads in the nighttime).

Since the 1^{st} driver has a lower driver score than the 2^{nd} driver based on the respective multi-component values (i.e., 0.590<0.843), the 1^{st} driver is identified by the controller 44 in the step 130 as a preferred driver for the second route 20₂.

Furthermore, since the 2^{nd} route 20₂ has a lowest driver score than a lowest driver score for the 1^{st} route 20₁ based on the respective multi-component values (i.e., 0.590<0.638), the 2^{nd} route 20₂ is identified by the controller 44 in the step 130 as a preferred route. The first driver has already been identified as the preferred driver for the second route 20₂.

In addition to identifying which of the drivers is preferable for the routes 20, the controller 44 optionally identifies, in a step 132, which of the drivers is preferable along each of the individual segments 30 of the respective routes 20. For example, although the 1^{st} driver is identified as the preferred driver for the first route 20₁, the 2^{nd} driver actually has a lower component value along the first segment 30_{1,1} of the first route 20₁. More specifically, the 1^{st} driver is identified as having a component value of 0.55 (i.e., 0.1/1.1 (ratio of time on city roads in the first area 12₁ (e.g., daytime) 30_{1,1} to total time of the first route 20₁)*0.60 (percentage score of 1^{st} driver on city roads in the daytime) for the first segment 30_{1,1} of the first route 20₁. The 2^{nd} driver is identified as having a component value of 0.035 (i.e., 0.1/1.1 (ratio of time on city roads in the first area 12₁ (e.g., daytime) 30_{1,1} to total time of the first route 20₁)*0.38 (percentage score of 2^{nd} driver on city roads in the daytime) for the first segment 30_{1,1} of the first route 20₁. Therefore, since the 2^{nd} driver has a lower component score than the 1^{st} driver along the first segment 30_{1,1} of the first route 20₁ (i.e., 0.035<0.055), the 2^{nd} driver is identified as a preferred driver along the first segment 30_{1,1} of the first route 20₁. Consequently, although the controller 44 identifies the 1^{st} driver as the preferred driver for the first route 20₁, the controller 44 also identifies the 2^{nd} driver as the preferred driver for first segment 30_{1,1} of the first route 20₁.

In another embodiment, it is also contemplated that in order to be identified as a preferred driver for any of the routes 20 and/or segments 30, each of the respective component values for the segments 30 for a particular driver must be below a predetermined threshold. Therefore, as discussed in the above example, the 1^{st} driver was identified as the preferred driver for the first route 20₁. However, the 1^{st} driver had a driver component score of 0.2909 for the segment 30_{1,3} (i.e., 0.4/1.1 (ratio of time on city roads in the second area 12₂ (e.g., nighttime) 30_{1,3} to total time of the first route 20₁)*0.80 (percentage score of 1^{st} driver on city roads in the nighttime)). If each of the component scores for each of the segments 30_{1,1-4} is required to be less than a respective predetermined threshold (e.g., <0.25 for the segment 30_{1,3}) for a driver to be identified as the preferred driver for the first route 20₁, the 1^{st} driver would not be identified as a preferred driver for the first route 20. In this case, since the component score of the 2^{nd} driver for the segment 30_{1,3} is also greater than the predetermined threshold (e.g., <0.25 for the segment 30_{1,3}), neither of the drivers would be identified as a preferred driver of the first route 20₁. Therefore, in this embodiment, another driver would need to be identified for the first route 20₁.

By identifying preferable drivers for the segments 30 and routes 20 in the manner discussed above, the controller 44 acts to rate the drivers for at least one of the segments 30 and at least one of the routes 20 based on the respective multi-component driving scores. In one embodiment, the controller 44 also acts to rank the drivers, in a step 134, relative to each other for at least one of the segments 30 and at least one of the routes 20 based on the respective multi-component driving scores.

In a step 136, the controller 44 transmits signals to the output device 46 for conveying (e.g., displaying) the respective preferred driver for each of the routes 20 and, optionally, each of the segments 30 via the output device 46. In one embodiment, the respective ranks of each of the drivers for one or more of the routes 20 and segments 30 the is conveyed via the output device 46. It is also contemplated that graphical representations of the routes 20 are displayed on the output device 46 in the step 136. In a step 140, the respective preferred driver for each of the routes 20 and, optionally, each of the segments 30 and driver rankings are conveyed to the user via the output device 46.

As discussed above, it is to be understood that the controller 44 acts as a means for associating each of a plurality of segments 30 of a route 20 with a respective one of a plurality of segment types. The controller 44 also acts as a means for identifying, for each of the plurality of drivers, a respective segment type value associated with each of the segment types, as a means for identifying the first condition value associated with the first condition, as a means for identifying the second condition value associated with the second condition, and as a means for identifying the driver score including the respective component values based on the segment type values, the first condition value, and the second condition value. The controller 44 also acts as a means for rating the drivers for one of the segments 30 based on the respective multi-component driving scores.

In one embodiment, the step 130 of identifying the preferred drivers for the routes assumes the respective number of safety events per driven mile incurred by each of the drivers while driving in the respective segment types at a given time of day, under given weather conditions, with a given truck, etc. is known for each driver on the respective segments 30 on which the driver has driven. Therefore, the expected total number of safety events for each driver on a given route 20 (consisting of a series of segments 30) may be computed. The expected number of safety events may be viewed as a cost of assigning a particular driver to a particular route.

In a case where there are a plurality of routes and a plurality of possible drivers for the routes, a decision may be made which driver is assigned to which route based on the expected number of safety events each of the drivers has for the particular routes. In other words, the decision as to which driver is assigned to which route is based on the cost of assigning the respective driver to the particular route. The basis for making such a decision may be expressed using a table showing persons/drivers and their jobs/routes 20. In one embodiment, it is desirable to minimize the total number of expected safety events for the different jobs/routes. Stated differently, it is desirable to minimize the total costs (e.g., safety costs) for the different jobs/routes.

Minimizing the total costs of assigning drivers to the different jobs/routes, where only a single driver may be assigned to a particular route, is generally known as an Assignment problem or as optimizing the available drivers for the routes. The Hungarian Method is a classical solution to the Assignment problem. Once the total safety costs for each driver along particular segments 30 of a route 20 are determined (as discussed above), the Hungarian Method may be used for assigning the drivers to the routes 20. Knowing the total expected costs makes it possible to decide which driver should take which of the routes 20. In the situation where there are more routes than drivers, it is also possible to determine which routes to do when, perhaps, a single driver could get two (2) routes—one during the day and the other during the night. In another situation where there are more drivers than routes, it is also possible to determine which drivers should not be assigned to a route (based on the high costs for that driver on the routes).

In one example, an assignment problem has four (4) drivers available for four different routes. Only one driver can be assigned to any one route. In this example, the step 130 of identifying the preferred drivers for the routes is based on the cost of assigning each driver to each route according to the following table:

Route

| Driver | Route 1 | Route 2 | Route 3 | Route 4 |
|---|---|---|---|---|
| Driver A | 20 | 25 | 22 | 28 |
| Driver B | 15 | 18 | 23 | 17 |
| Driver C | 19 | 17 | 21 | 24 |
| Driver D | 25 | 23 | 24 | 24 |

The objective in the step 130 is for the processor 44 to optimize the assignment of drivers to the routes by assigning drivers to routes such that the total cost of assignment is a minimum. In the example illustrated in the table, the total minimum cost is achieved by:

$$\begin{matrix}Total Cost = A 1 + B 4 + C 2 + D 3 \\ = 20 + 17 + 17 + 24 \\ = 78\end{matrix}$$

Therefore, in the example of the step 130 illustrated in the table, to achieve the total minimum cost (e.g., the optimized assignment of drivers), Driver A is assigned to Route 1, Driver B is assigned to Route 4, Driver C is assigned to Route 2, and Driver D is assigned to Route 3. It is understood that the Hungarian Method is only one example that may be used for finding the total minimum cost of assigning drivers to routes.

It is also contemplated that time plays a significant role in the assignment problem and, in one embodiment, is accounted for in the assignment of the drivers to the routes. For example, the local weather report may make a route's conditions different.

A first route including three (3) segments (e.g., a first dry segment, a second segment expected to be snowy (very slippery) per a weather report, and a third segment expected to be wet (slippery) with melting snow). Without the snowy weather report, all three (3) of the segments may be expected to be dry driving conditions, which would be suitable to a first set of drivers that have lower total safety costs for drier driving conditions. However, with the snowy weather report making the second and third segments slippery, a second set of drivers that have lower total safety costs for driving on more slippery roads may be more suitable for optimizing the assignment of drivers to the routes. Furthermore, the weather and changed travel times (e.g., slower travel time in snowy road conditions) may change the tasks because the conditions are different. For example, because travel may be slower than usual, the final segment may be driven in nighttime conditions, and so the current hours of daylight on a particular day also play a role in assigning drivers to routes.

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicant's general inventive concept.

We claim:

1. A method for rating drivers, the method comprising:
associating each of a plurality of segments of a route with a respective one of a plurality of segment types;
for each of the plurality of drivers:
identifying a respective segment type value associated with each of the segment types;
identifying a first condition value associated with a first condition;
identifying a second condition value associated with a second condition; and
identifying a driver score including respective component values based on the segment type values, the first condition value, and the second condition value; and
rating the drivers for one of the segments based on the respective multi-component driving scores.

2. The method for rating drivers as set forth in claim 1, wherein the step of associating each of a plurality of segments includes:
associating each of the segments as one of a city segment type and a highway segment type.

3. The method for rating drivers as set forth in claim 1, further including:
identifying the first condition as daytime driving; and
identifying the second condition as nighttime driving.

4. The method for rating drivers as set forth in claim 1, further including, for each of the drivers:
for each of the segment types, identifying the respective segment type value based on a segment driving history value of the driver while driving in the segment type.

5. The method for rating drivers as set forth in claim 4, further including, for each of the drivers:
for each of the segment types, identifying the segment driving history value based on a number of safety events incurred by the driver while driving in the respective segment type.

6. The method for rating drivers as set forth in claim 1, wherein:
the step of identifying a first condition value includes:
identifying the first condition value based on a first driving history value of the driver while driving in the first condition; and
the step of identifying a second condition value includes:
identifying the second condition value based on a second driving history value of the driver while driving in the second condition.

7. The method for rating drivers as set forth in claim 6, further including:
identifying the first driving history value based on a number of safety events incurred by the driver while driving in the first condition; and
identifying the second driving history value based on a number of safety events incurred by the driver while driving in the second condition.

8. The method for rating drivers as set forth in claim 7, further including:
for each of the segment types, identifying a first condition-segment value based on the first driving history value of the driver while driving in the first condition and the respective segment type; and
for each of the segment types, identifying a second condition-segment value based on the second driving history value of the driver while driving in the second condition and the respective segment type.

9. The method for rating drivers as set forth in claim 1, further including:
identifying an itinerary as including at least one portion, each of the at least one portions identifying one of the segments and one of the first condition and the second condition associated with the segment.

10. The method for rating drivers as set forth in claim 9, further including, for each of the at least one portions:
identifying any of the driver scores having at least one of the component values below respective predetermined thresholds for the segment and the one of the first and second conditions.

11. The method for rating drivers as set forth in claim 9, further including:
identifying the itinerary as including a respective length of time for each of the at least one portions.

12. The method for rating drivers as set forth in claim 1, further including:
associating each of a plurality of segments of a second route with respective ones of the plurality of segment types;
for each of the plurality of drivers identifying a respective driver score for each of the routes; and
optimizing the assignment of drivers to the routes.

13. The method for rating drivers as set forth in claim 12, wherein the optimizing step includes:
assigning the drivers to the routes such that the total cost of assignment is a minimum based on the respective driver scores for each of the routes.

14. A processor for rating drivers, the processor comprising:
means for associating each of a plurality of segments of a route with a respective one of a plurality of segment types;
for each of the plurality of drivers:
means for identifying a respective segment type value associated with each of the segment types;
means for identifying a first condition value associated with a first condition;
means for identifying a second condition value associated with a second condition; and
means for identifying a driver score including respective component values based on the segment type values, the first condition value, and the second condition value; and
means for rating the drivers for one of the segments based on the respective multi-component driving scores.

15. A controller for rating drivers, the controller adapted to:
associate each of a plurality of segments of a route with a respective one of a plurality of segment types;
for each of the plurality of drivers, the controller adapted to:
identify a respective segment type value associated with each of the segment types;
identify a first condition value associated with a first condition;
identify a second condition value associated with a second condition; and
identify a driver score including respective component values based on the segment type values, the first condition value, and the second condition value; and
rate the drivers for one of the segments based on the respective multi-component driving scores.

16. The controller as set forth in claim 15, further adapted to:
associate each of the segments as one of a city segment type and a highway segment type.

17. The controller as set forth in claim 15, further adapted to:
identify the first condition as daytime driving; and
identify the second condition as nighttime driving.

18. The controller as set forth in claim 15, further adapted to, for each of the segment types:
identify the respective segment type value based on a segment driving history value of the driver while driving in the segment type.

19. The controller as set forth in claim 15, further adapted to:
identify the first condition value based on a first driving history value of the driver while driving in the first condition; and
identify the second condition value based on a second driving history value of the driver while driving in the second condition.

20. The controller as set forth in claim 19, further adapted to:
identify the first driving history value based on a number of safety events incurred by the driver while driving in the first condition; and
identify the second driving history value based on a number of safety events incurred by the driver while driving in the second condition.

21. The controller as set forth in claim 20, further adapted to, for each of the segment types:
identify a first condition-segment value based on the first driving history value of the driver while driving in the first condition and the respective segment type; and
identify a second condition-segment value based on the second driving history value of the driver while driving in the second condition and the respective segment type.

22. A system for rating drivers, the system comprising:
a controller adapted to:
associate each of a plurality of segments of a route with a respective one of a plurality of segment types;
for each of a plurality of drivers, the controller adapted to:
receive a respective segment type value associated with each of the segment types;
receive a first condition value associated with a first condition;
receive a second condition value associated with a second condition; and
determine a driver score including respective component values based on the segment type values, the first condition value, and the second condition value; and
rate the drivers for each of the segments based on the respective multi-component driving scores;
an input device receiving an input identifying an itinerary including at least one portion, each of the at least one portions identifying one of the segments and one of the first condition and the second condition associated with the segment, the controller being further adapted to identify any of the drivers with the respective component values below predetermined thresholds for each of the at least one portions; and;
an output device communicating an output identifying the drivers with the respective component values below the predetermined thresholds for each of the at least one portions.

23. The system for rating drivers as set forth in claim 22, wherein the controller is further adapted to:
identify any of the drivers with the respective component values below predetermined thresholds for any of the at least one portions.

24. The system for rating drivers as set forth in claim 22, wherein:
the output device includes a visual output for displaying the drivers with the respective component values below predetermined thresholds.

25. The system for rating drivers as set forth in claim 22, wherein:
the input device includes a manual input for receiving the input identifying the itinerary.

26. The system for rating drivers as set forth in claim 22, wherein the controller is further adapted to:
identify the first condition value based on a number of safety events incurred by the driver while driving in the first condition; and
identify the second condition value based on a number of safety events incurred by the driver while driving in the second condition.

27. The system for rating drivers as set forth in claim 26, wherein, for each of the segment types, the controller is further adapted to:
identify a first condition-segment value based on the number of safety events incurred by the driver while driving in the first condition and the respective segment type; and
identify a second condition-segment value based on the number of safety events incurred by the driver while driving in the second condition and the respective segment type.

28. The system for rating drivers as set forth in claim 27, wherein the controller is further adapted to:
rate the drivers for each of the segments based on the respective first condition-segment values and the second condition-segment values.

29. A controller for rating drivers, the controller adapted to:
associate each of a plurality of segments of a route with a respective one of a plurality of segment types;
for each of the plurality of drivers, the controller adapted to:
identify respective first condition-segment values based on a number of safety events incurred by the driver while driving in the first condition and the respective segment type; and
identify respective second condition-segment values based on a number of safety events incurred by the driver while driving in the second condition and the respective segment type; and
identify a driver score including respective component values based on the first condition-segment values and the second condition-segment values;
identifying an itinerary as including at least one portion, each of the at least one portions identifying one of the segments and one of the first condition and the second condition associated with the segment; and
rank the drivers for the at least one portion of the itinerary based on the driver scores.

30. The controller for rating drivers as set forth in claim 29, wherein the controller is further adapted to:
rank the drivers for the itinerary based on the respective driver scores.

31. The controller for rating drivers as set forth in claim 29, wherein the controller is further adapted to:
transmit a signal to an associated output device for conveying the rank of the drivers.

32. The controller for rating drivers as set forth in claim 29, wherein the controller is further adapted to:
identify a second itinerary as including at least one portion, each of the at least one portions identifying one of the segments and one of the first condition and the second condition associated with the segment; and
optimize the plurality of drivers for the itinerary and the second itinerary by assigning one of the drivers to each of the itineraries to minimize a total number of expected safety events.
